(19) United States
(12) Patent Application Publication
(10) Pub. No.: US 2006/0098958 A1
(43) Pub. Date: May 11, 2006

(54) Optical disk system and combination of video display system with optical disk system

(75) Inventors: Akihiro Ohmori, Tokyo (JP); Shinji Umehara, Tokyo (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC Corporation

(21) Appl. No.: 11/269,502

(22) Filed: Nov. 8, 2005

(30) Foreign Application Priority Data
Nov. 9, 2004 (JP) 2004-324797

(51) Int. Cl. H04N 5/781

(52) U.S. Cl. 386/125; 386/126

(57) ABSTRACT

A TV/DVD combination unit is roughly divided into a television section and a DVD section. A tuner of the television section outputs a received television signal to a display section and the DVD section. The DVD section records the output television signal onto a DVD. A microprocessor of the DVD section and a microprocessor of the television section are connected through a serial bus, and are in communication with each other. When necessary, the microprocessor of the DVD section instructs the microprocessor of the television section to switch a receiving channel of the tuner. The television section performs switching of the receiving channel of the tuner in accordance with that instruction.

### BACKGROUND OF THE INVENTION

1. Field of the Invention

The present invention relates to an optical disk system that records and plays back data to and from an optical disk, and which is connected to a video display system that displays video images, and further relates to a combination of a video display system with such an optical disk system wherein the optical disk system is combined with a television receiver.

2. Description of the Related Art

Heretofore, television receivers having built-in VCRs that record and play back video images to and from magnetic tapes, or so-called “TV/VCR combos”, have been widely known. Most of such television receivers combined with built-in VCRs have a structure wherein a display system is combined with a VCR having a built-in tuner, and control of receiving channels and other operations are performed on the VCR side.

On the other hand, in recent years, as substitutes for magnetic tapes, optical disks such as DVDs are being widely used as video recording media. In parallel, as substitutes for VCRs, for example, DVD playback systems and DVD recorder systems are also being introduced and put into widespread use.

Under the circumstances, television receivers provided with built-in DVD systems, in which a television receiver is combined with a DVD playback system and/or a DVD recorder system, are being proposed in a part of the market. For example, Japanese Patent Laid-Open Publication No. 2003-32508 discloses a video output device wherein a DVD playback system and a television receiver are combined. The video output device disclosed therein includes a typical television receiver provided with a tuner, and a DVD player capable of playing back DVDs, wherein the television receiver and the DVD player are connected through a control bus such as an I2C bus. An operational instruction generated by a user's operation of a remote control is received on the television receiver side. The operational instruction received by the television receiver is then input to the DVD playback system through the control bus, and the DVD playback system performs various types of operations in accordance with the operational instruction.

However, the above-described video output device is only capable of playing back DVDs, and is not capable of recording video images onto DVDs. Therefore, such a video output device cannot be used as a substitute for a conventional TV/VCR combination. Thus, a combination of a TV set and a DVD recording and playback system having a built-in tuner currently available on the market has been proposed. In this case, because the recording and playing back of video images to and from a DVD can both be performed, such a combination can be used sufficiently as a substitute for a TV/VCR combination.

However, DVD recording and playback systems having a built-in tuner currently available on the market are feature rich and thus expensive. Therefore, when such a DVD recording and playback system is combined with a television receiver, a TV/DVD combination will also be expensive. Generally, it is expected that combination products combining a video recording and playback system and a television receiver are priced in a relatively low price range, and high-priced combination products are not desirable. In addition, when a feature-rich DVD recording and playback system having a built-in tuner is combined with a television receiver, there is a problem in that many design changes or other changes to the television receiver are required.

### SUMMARY OF THE INVENTION

According to one aspect of the present invention, there is provided an optical disk system that records and plays back data to and from an optical disk, and which is connected to a video display system that displays a video image. The optical disk system includes a communication device that bidirectionally communicates a control signal to and from the video display system; an input interface that receives input of a video signal from the video display system; a recording device that records an input video signal onto an optical disk; and a control device that controls the overall optical disk system. The control device outputs, through the communication device to the video display system, at least a control signal for instructing switching of a type of video signal that is to be input to the input interface.

In a preferred embodiment, the video display system is a television receiver system that includes a tuner for receiving and demodulating a television broadcast, and outputs a television signal received by the tuner to the optical disk system, and the control device outputs a control signal for instructing switching of a receiving channel of the tuner as the control signal for instructing switching of the type of video signal that is to be input. It is also preferable that the control device further outputs, to the video display system, a control signal for instructing switching of the tuner ON and OFF.

In another preferred embodiment, the optical disk system further includes a playback device that plays back data stored on an optical disk, and an output interface that outputs the played back data to the video display system. In this optical disk system, the control device further outputs, to the video display system, a control signal for instructing that a type of signal to be input to a display section of the video display system is switched to the played back signal output from the output interface or other type of video signal.

According to another aspect of the present invention, there is provided a combination of an optical disk system and a video display system, the combination comprising a television receiver system and an optical disk system connected to the television receiver system. The television receiver system includes a tuner for receiving and demodulating a television broadcast, and for outputting, to the optical disk system, a video signal representing the received television broadcast; a television side communication device that bidirectionally communicates a control signal to and from the optical disk system; and a television side control device that controls the overall television receiver system, and controls the television receiver system in accordance with a control signal received from the optical disk system through the television side communication device. The optical disk system includes a recording device that records a video signal input from the tuner onto an optical disk; an optical disk side communication device that bidirectionally communicates a control signal to and from the television receiver system; and an optical disk side control device that controls the overall optical disk system in accordance with a control signal received through the optical disk side communication device, and outputs, to the television receiver system, at least a control signal for instructing switching of a receiving channel of the tuner.

As used herein, the term “optical disk” generally refers to recording media, such as DVDs, HD-DVDs, and Blu-ray disks, to and from which data can be recorded and reproduced by means of application of laser light to the disk. The term “optical disk system” generally refers to devices capable of recording and reproducing data to and from an optical disk. The term “tuner” generally refers to devices capable of receiving and demodulating television broadcasting. Such devices include a television tuner for receiving analog television signals, a digital tuner for receiving digital television signals, a BS tuner for receiving BS digital broadcasting, a CS tuner for receiving CS broadcasting, and the like. The term “video signal” refers to a signal that includes both a visual signal and an audio signal.

According to the present invention, because the obtaining of a video signal itself is performed by a video display system (television receiver system), an optical disk system itself can be manufactured at low cost. Furthermore, the number of design changes to the video display system (television receiver system) itself can also be reduced. As a result, a video display system combined with an optical disk system can be easily achieved.

### BRIEF DESCRIPTION OF THE DRAWINGS

Preferred embodiments of the present invention will be described in further detail based on the following drawings, wherein:

FIG. 1 is a block diagram showing a schematic structure of a television set combined with a DVD system according to an embodiment of the present invention;

FIG. 2 is a block diagram showing a more detailed structure of a DVD section;

FIG. 3 is a flowchart showing the process of recording data in accordance with a recording schedule in the television set combined with the DVD system;

FIG. 4 is a flowchart showing the process of recording data in accordance with a recording schedule in the television set combined with the DVD system;

FIG. 5 is a flowchart showing the process of playing back a DVD in the television set combined with the DVD system; and

FIG. 6 is a block diagram showing a schematic structure of a television set combined with a DVD system according to another embodiment of the present invention.

### DESCRIPTION OF PREFERRED EMBODIMENTS

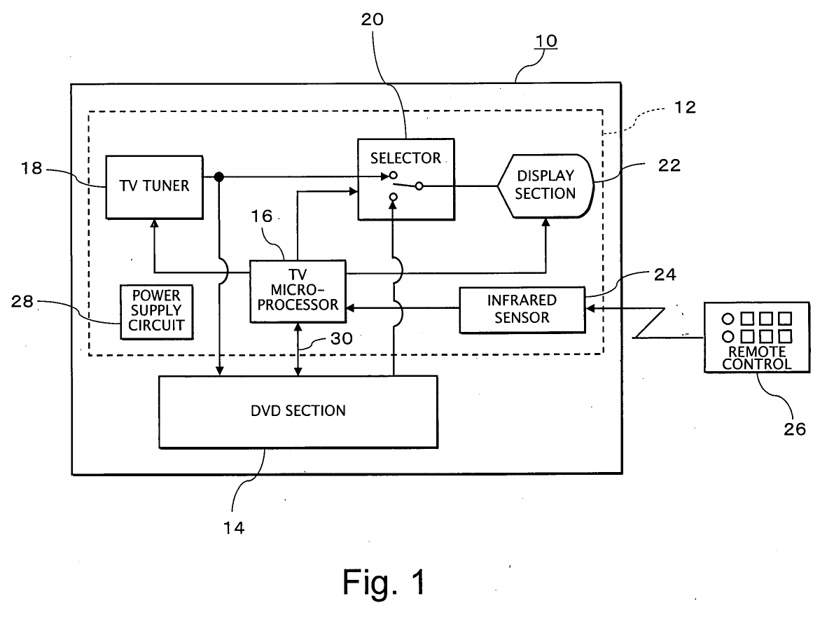

Preferred embodiments of the present invention will be described below with reference to the drawings. FIG. 1 is a block diagram showing a schematic structure of a television set combined with a DVD system (TV/DVD combination) 10 according to an embodiment of the present invention. The TV/DVD combination 10 is roughly divided into a television section 12 and a DVD section 14. The television section 12 and the DVD section 14 are bus-connected and in communication with each other. The television section 12 and the DVD section 14 are housed in the same cabinet, and can be regarded as a single video display device.

The television section 12 has a structure similar to that of an ordinary television receiver. Specifically, the television section 12 includes a television tuner 18 that receives a television signal, a display section 22 that displays an image and outputs a sound, a selector 20 that selects a signal to be input to the display section 22, an infrared sensor 24 that receives an operational instruction from a remote control 26, a power supply circuit 28 that supplies power to individual parts, and a television microprocessor 16 that is designed for use in the television section, and which controls the above components of the television section 12.

The television tuner 18 is connected to a receiving antenna (not shown), and receives and demodulates a television signal (including a visual signal and an audio signal) of a program that is being broadcast on a selected channel from among television signals received through the receiving antenna. The channel to be selected is switched in accordance with an instruction from the television microprocessor 16. The television signal received by the television tuner 18 is output to the selector 20 and the DVD section 14. Here, although in the present embodiment it is assumed that a tuner for receiving analog television signals is used as the television tuner, the present invention is not limited to such an embodiment. For example, a digital tuner for receiving digital television signals may also be used. Further, the television section 12 may also be provided with a BS tuner for receiving BS digital broadcasting and/or a CS tuner for receiving CS broadcasting.

The selector 20 is used to select input to the display section 22, and is controlled by the television microprocessor 16. The selector 20 selects input to the display section 22 in accordance with an instruction from the television microprocessor 16 to receive either a television signal output from the television tuner 18 or a signal output from the DVD section 14. The display section 22 includes a monitor for displaying images and a loudspeaker for outputting sounds, and outputs and displays a signal selected by the selector 20.

The infrared sensor 24 receives an operational instruction from the remote control 26, and outputs the content of that instruction to the television microprocessor 16. Here, the operational instruction input from the remote control 26 includes not only an operational instruction concerning the operation of the television section 12, but also an operational instruction concerning the operation of the DVD section. In other words, the TV/DVD combination 10 is configured such that a user can operate both the television section 12 and the DVD section 14 using a single remote control 26.

Power supply to the individual parts of the television section 12 is provided from the power supply circuit 28 (however, in FIG. 1, power supply lines are omitted). The power supply circuit 28 causes the mode of power supply to be changed in accordance with an instruction from the television microprocessor 16. The mode of power supply includes a “suspend” mode, a “partially operating” mode, an “operating” mode, and the like. The suspend mode is a mode in which power is supplied only to the television microprocessor 16 and the infrared sensor 24, and no power is supplied to the television tuner 18 and the display section 22. The partially operating mode is a mode in which power is supplied to the television microprocessor 16, the infrared sensor 24, the television tuner 18, and the selector 20, and no power is supplied to the display section 22. This mode is mainly selected when the DVD section 14 is used to record a television program while the display section 22 is held off. The operating mode is a mode in which power is supplied to all the devices of the television section.

The television microprocessor 16 is a microprocessor for controlling the overall television section 12, and which outputs a control signal to the individual parts of the television section 12. The control signal to be output includes a signal for switching the channel of the television tuner 18, a signal for switching the mode of power supply, a signal for switching the input to the display section, and the like. These types of control signals are output in accordance with an operational instruction received by the infrared sensor 24.

Further, the television microprocessor 16 is connected to the DVD section 14 through a serial bus, or, for example, a universal asynchronous receiver/transmitter (UART) 30, and is capable of intercommunicating with the DVD section 14. The UART 30 as used herein is also referred to as “RS232C”, which is a communication circuit used in serial communication. Most microprocessors currently available on the market are equipped with an interface for the UART 30. In other words, the television section 12 can be connected with the DVD section 14 through the use of the UART 30 without any substantial changes to the structure of a typical television receiver. However, the present invention is not limited to an embodiment using a UART, but other embodiments using other types of connection lines may be employed as long as intercommunication with the DVD section 14 is possible.

The television microprocessor 16 outputs an operational instruction to the DVD section 14 through the UART 30, and receives input of an operational instruction from the DVD section 14 through the UART 30. As described, an operational instruction for operating the DVD section 14 is also received by the television microprocessor 16 through the infrared sensor 24 provided in the television section 12. The television microprocessor 16 outputs the operational instruction for operating the DVD section 14 through the UART 30 to the DVD section 14. In reverse, an operational instruction may also be output from the DVD section 14 to the television section 12. For example, when a scheduled recording is to be performed, instructions for switching the channel of the television tuner 18 and/or for ON/OFF switching of the television tuner 18 are provided from the DVD section 14 to the television section 12. Further, when a DVD is to be played back, an instruction for switching the selector 20 (selecting a signal to be input to the display section 22) is also provided from the DVD section 14 to the television section 12. When such an operational instruction is input, the television microprocessor 16 performs control over the television section 12 in accordance with that operational instruction. The operational instruction transmitted and received in this process is transmitted and received in the form of a command indicating the content of that operational instruction. For this purpose, the television microprocessor 16 converts an operational instruction to be transmitted into a command, or interprets a received command, as necessary.

As is clear from the above description, although control by the television microprocessor 16 is performed in a slightly different manner, and a television signal extracted by the television tuner 18 is output to a slightly different destination, the television section 12 basically has almost the same structure as that of a conventional television receiver. Also, with regard to the control performed by the television microprocessor 16, basically, it is sufficient that only control corresponding to a command to be transmitted or received through the UART 30 is additionally performed, and no significant change is made. In other words, it can be understood that the television section 12 used in the present embodiment can be achieved by simply employing the structure of a conventional television receiver. As a result, the television section 12 connected with the DVD section 14 can be formed more easily and at lower cost.

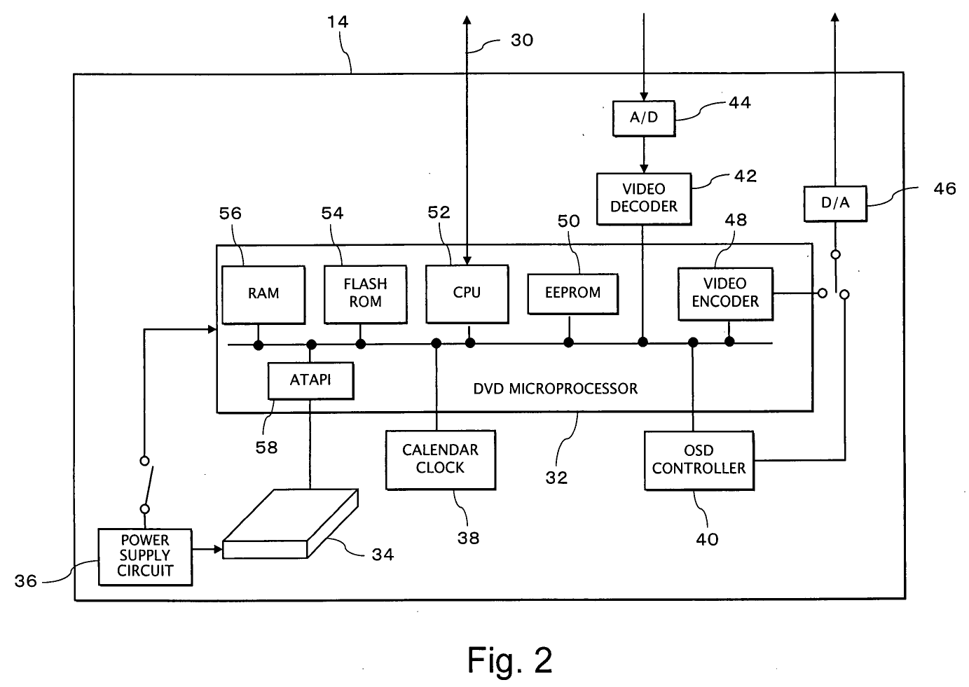

Next, the DVD section 14 will be described with reference to FIG. 2. FIG. 2 is a block diagram showing a more detailed structure of the DVD section 14. The DVD section 14 performs recording of data to a DVD (digital versatile disk) and playback of data stored on a DVD.

The writing and reading of data to and from a DVD is performed using a DVD drive 34. The DVD drive 34 can be formed by employing the structure of a well-known optical disk drive having an optical pickup and the like. This DVD drive 34 is connected through an ATAPI interface to a DVD microprocessor 32 that is designed for use in the DVD section. Data to be recorded is supplied from the DVD microprocessor 32 through the ATAPI 58. Further, data reproduced from a DVD is output to the DVD microprocessor 32 through the ATAPI 58. Further, the DVD drive 34 includes a loading mechanism having an arm (not shown), which also has the function of detecting the medium. When a medium is inserted into the DVD drive 34, the internal arm is pressed by contact with the edge of the medium, a microswitch associated with that arm is turned on and causes the loading mechanism to operate, and a medium insertion signal is transmitted to the DVD microprocessor 32 through a microprocessor provided within the DVD drive 34.

Further, the DVD drive 34 operates by receiving power supply from a power supply circuit 36, and is configured such that the mode of power supply can be changed in accordance with the mode of operation of the DVD drive 34 itself. This is controlled by means of a controller (not shown) provided within the DVD drive 34. The mode of operation includes an “active” mode in which the disk is accessed in accordance with an instruction from the DVD microprocessor 32, an “idle” mode in which the disk is made to continuously rotate to wait for a new instruction while the servo of the pickup and the like are held on after the access operation is completed, a “standby” mode in which only the internal microprocessor is maintained in an operational state while the rotation of the disk, the servo of the pickup, and the like are suspended, and a “sleep” mode in which all functions other than that of an interface microprocessor (not shown) for receiving an instruction from the DVD microprocessor 32 are suspended. The controller of the DVD drive 34 selects, in accordance with the mode of operation as described above, components to which power is to be supplied. By thus selecting the components to which power is to be supplied, or in other words, selecting the amount of power supply in accordance with the mode of operation, the DVD drive 34 can always be operated at minimum power.

The DVD microprocessor 32 is a microprocessor for controlling the overall DVD section 14, and includes a CPU 52, a ROM 54, a RAM 56, and the like. The control by this DVD microprocessor 32 is performed basically in accordance with commands transmitted from the television section 12. More specifically, the DVD microprocessor 32 is connected to the television microprocessor 16 of the television section 12 through the UART 30, and receives operational instructions transmitted from the television microprocessor 16 in the form of commands. The CPU 52 of the DVD microprocessor 32 interprets the received command, and performs various types of control operations corresponding to that command, such as, for example, recording or playback of data. On the other hand, a command may also be transmitted from the DVD microprocessor 32 to the television microprocessor 16. For example, the DVD section 14 of the present embodiment is configured to be able to perform a scheduled recording for which recording of a television program is started from a preset time. At the time of starting the scheduled recording, the DVD microprocessor 32 outputs, to the television section 12, an instruction for turning on the television tuner 18, an instruction for switching the channel of the television tuner 18, and other instructions. Further, when data stored on a DVD is to be played back, the DVD microprocessor 32 outputs, to the television section 12, an instruction for switching the input to the display section 22 so that an output signal from the DVD section 14 is input to the display section 22.

As described above, the DVD section 14 receives a television signal input from the television tuner 18 of the television section 12. The television signal is an NTSC analog video signal, and is therefore subjected to NTSC decoding performed by a video decoder 42 after A/D conversion by an A/D converter 44. The resultant data is stored and held in the RAM 56 of the DVD microprocessor 32. The digital video data stored in the RAM 56 is then subjected to MPEG encoding performed by the CPU 52. Then, the MPEG encoded data is output to the DVD drive 34 in the form of an MPEG file, and is recorded on a DVD (recording of a television program). In other words, according to the present embodiment, the television tuner 18 of the television section 12 is used to obtain a television signal to record a television program. Therefore, it is not necessary to provide a television tuner in the DVD section 14. As a result, the TV/DVD combination 10 can be formed at low cost.

Further, data obtained by playing back a DVD by the DVD drive 34 is also temporarily stored in the RAM 56. After that, the data is subjected to MPEG decoding performed by the CPU 52, and is then subjected to NTSC encoding performed by a video encoder 48. The resultant data is further subjected to D/A conversion performed by a D/A converter 46, and is output to the selector 20 of the television section 12. As will be described below, when a DVD is being played back, the selector 20 outputs an output signal from the DVD section 14 to the display section 22. Therefore, a playback signal output from the DVD section 14 is output and displayed on the display section 22 of the television section 12. Thus, a user can view the content of the DVD.

Further, details of setting of a scheduled recording are also stored in the RAM 56. More specifically, as described above, the DVD section 14 of the present embodiment has the function of programming a recording schedule to enable recording (data recording) of a television broadcast at a preset time and channel. The details preset for the scheduled recording such as a recording start time, a recording end time, a record channel, and the like are stored in the RAM 56. Date and time management for a scheduled recording is achieved by means of a calendar clock 38. When a recording schedule is set, the CPU 52 causes the RAM 56 to store the details of that schedule therein. After that, when it is determined with reference to the calendar clock 38 that the scheduled time is reached, data recording (recording of a television program) to a DVD is started.

An on-screen display (OSD) controller 40 is a processor for causing various types of setting screens to be displayed on the monitor of the television section 12. The OSD controller 40 creates various types of setting screens, such as, for example, a recording schedule setting screen, in accordance with an instruction from the CPU 52. A created setting screen is output to the selector 20 of the television section 12 after D/A conversion. By thus providing the function of creating a setting screen on the DVD section 14 side, the television section 12 can be formed to have a structure substantially similar to that of a typical television receiver. Therefore, the TV/DVD combination 10 can be easily achieved without any significant change in the structure of a television receiver. Further, it is to be understood that the present invention is not limited to the above-described embodiment wherein a setting screen is displayed on the monitor, but can be applied to various modifications. For example, a separate display device such as a liquid crystal display or the like may be provided on the DVD section 14 side, thereby allowing a setting screen to be displayed on that display device. Alternatively, an OSD controller may be provided in the television section 12, and by allowing the DVD microprocessor 32 to control this OSD controller by way of the UART 30, a setting screen can be created and displayed on the television section side.

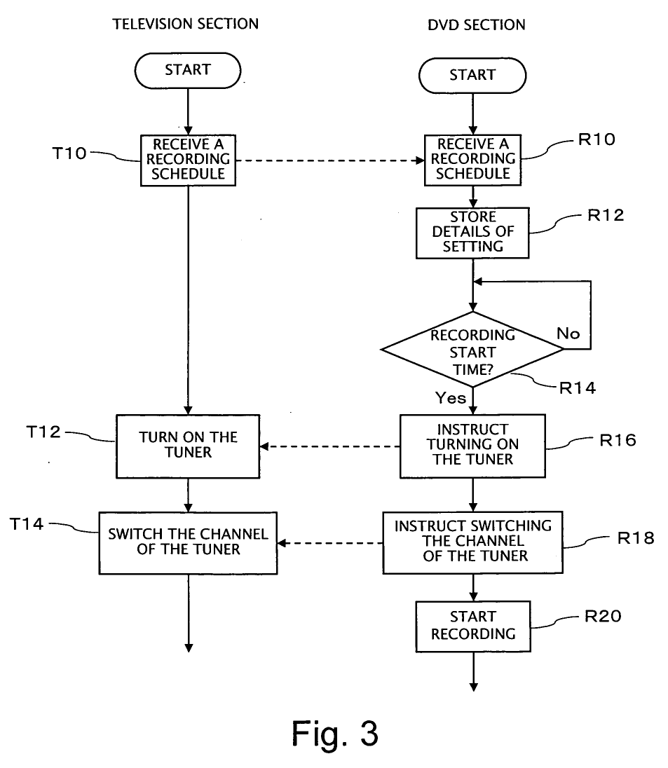

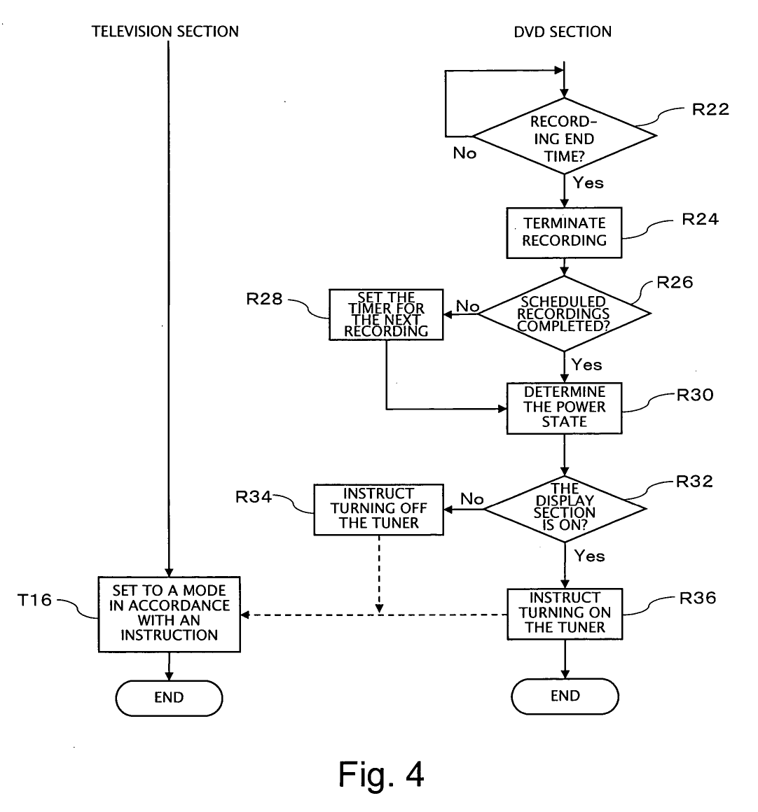

Next, the processes of data recording and playback performed by the TV/DVD combination 10 will be described below. First, as an example of data recording, the process of performing a scheduled recording will be described with reference to FIGS. 3 and 4.

When a scheduled recording is to be performed, a user first operates a remote control to set a recording schedule. At this time, an operational signal transmitted from the remote control is received by the television section 12, and is then converted into a command, which is further transmitted to the DVD microprocessor 32 (T10, R10). The DVD microprocessor 32 performs various types of processing corresponding to the transmitted command, such as, for example, outputting of a recording schedule setting screen and the like. Then, the details preset for the recording schedule such as the recording start time, the recording end time, the record channel, and the like are stored in the RAM 56 (R12). After setting of the recording schedule is completed, the DVD microprocessor 32 outputs an instruction to the controller of the DVD drive 34 to cause the mode of operation to be switched to the sleep mode.

The CPU 52 of the DVD microprocessor 32 refers to the details of setting of the recording schedule stored in the RAM 56 and the calendar clock 38 (R14), and immediately before the recording start time, or, for example, one minute before the recording start time, starts preparing to start recording. Specifically, the DVD microprocessor 32 instructs the television section 12 to turn on the television tuner 18 (R16). This instruction is provided through transmission of a command representing turning on of the television tuner 18 from the DVD microprocessor 32 to the television microprocessor 16. In response to receipt of this command, the television microprocessor 16 controls the power supply circuit 28 to turn on the television tuner 18 (T12).

Subsequently, the DVD microprocessor 32 switches the channel to the one selected at the time of setting the recording schedule (R18). As described above, the DVD section 14 of the present embodiment uses the television tuner 18 of the television section 12 to obtain a television signal to be recorded. Therefore, the DVD microprocessor 32 provides an instruction to switch the channel of the television tuner 18 of the television section 12 through the television microprocessor 16. The television microprocessor 16 of the television section 12 switches the channel of the television tuner 18 in accordance with that instruction (T14). As a result, a television signal being broadcast on the channel selected in accordance with the instruction is output from the television tuner 18. This television signal is output to the DVD section 14.

When the television signal of the selected channel is output, the DVD microprocessor 32 drives the DVD drive 34 so that the television broadcast selected in accordance with the instruction is recorded on a DVD (R20). More specifically, the television signal input to the DVD section 14 is subjected to NTSC decoding performed by the video decoder 42 after A/D conversion, and the resultant signal is stored in the RAM 56. The CPU 52 of the DVD microprocessor 32 performs MPEG encoding on this digital signal stored in the RAM 56, and then outputs the MPEG encoded signal to the DVD drive 34. Then, the DVD drive 34 records the digital signal onto the DVD. Thus, the scheduled recording of the television broadcast is performed.

When the recording end time is reached (R22), the CPU 52 instructs the DVD drive 34 to terminate data recording, and the scheduled recording is completed (R24). Then, a determination is made as to whether or not another recording is scheduled to be performed later, and when another recording is scheduled, a timer is set (R28) to allow the next scheduled recording to be performed. Further, the DVD microprocessor 32 transmits a command to the television section 12 to query the power state of the display section 22 (R30). When it is determined as a result of the query that the power of the display section 22 is off, the television section 12 is instructed to turn off the power of the television tuner 18 (R34). By turning off the power of the television tuner 18, the television section 12 is switched to the suspend mode in which power is supplied only to the television microprocessor 16. Further, the DVD section 14 is also switched to a suspend mode by switching the DVD drive 34 to the sleep mode. On the other hand, when the power of the display section 22 is on, the state of the television section 12 is held as it is, or, in other words, both the display section 22 and the television tuner 18 are kept in the power-on state (R36). The DVD section 14 switches the DVD drive 34 to the sleep mode.

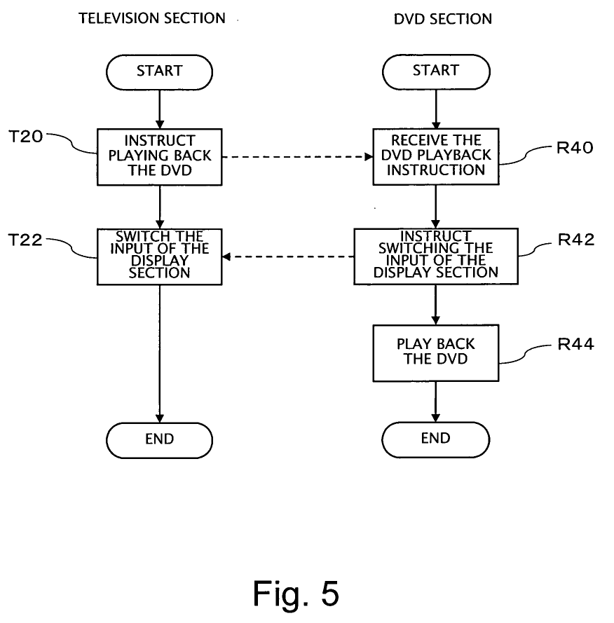

Next, the process of playing back a DVD will be described with reference to FIG. 5. When a user inputs an instruction to play back a DVD through the operation of a remote control, this operational instruction is received by the television microprocessor 16 of the television section 12. The television microprocessor 16 converts the operational instruction into a command, and transmits the command to the DVD section 14 (T20). The DVD microprocessor 32 of the DVD section 14 understands the command, and accepts the DVD playback instruction (R40).

The DVD microprocessor 32 that has accepted the DVD playback instruction instructs the television section 12 to switch the input of the display section 22 (R42). The television microprocessor 16 that has received this instruction instructs the selector 20 to switch the input of the display section 22 from the television tuner output to the DVD output (T22). As a result, the monitor and the loudspeaker of the display section 22 receive input of a signal output from the DVD section 14.

Subsequently, the DVD microprocessor 32 instructs the DVD drive 34 to play back data stored on the DVD (R44). The DVD drive 34 changes the mode of operation to “active”, and plays back data stored on the DVD that is being loaded. The played back data is temporarily stored in the RAM 56, and is then subjected to MPEG decoding performed by the CPU 52. Further, the video encoder 48 performs encoding to generate an NTSC digital video signal, and the D/A converter 46 converts the resultant signal to an NTSC analog video signal, which is then output to the television section 12.

In the television section 12, because the selector 20 is switched so that a signal output from the DVD section 14 is input to the display section 22, the signal played back from the DVD is output from the monitor and the loud speaker of the display section 22. Thus, the user can view the video recorded on the DVD. It is to be understood that when, at some point during the viewing, the user operates the remote control to thereby input an operational instruction, such as for fast forward, fast reverse, pause, or the like, the television microprocessor 16 transmits the input operational instruction to the DVD microprocessor 32, as appropriate. Then, the DVD microprocessor 32 performs control in accordance with that operational instruction.

As is obvious from the above description, control of the television section 12, power management of the television tuner 18, channel management, switching of input of the display section 22, and the like that are required for recording and playback of data to and from a DVD are all performed in accordance with an instruction from the DVD section 14. Therefore, it is to be understood that the television section 12 requires only the addition of the function of performing control in accordance with an instruction from the DVD section 14, and it is sufficient for the television section 12 to be formed to have almost the same structure and control as those of a typical television receiver. In other words, according to the present embodiment, a typical television receiver can be easily adopted for use in a TV/DVD combination. Therefore, a TV/DVD combination can be provided more easily and at lower cost.

Although the present embodiment is configured such that an operational instruction output from the remote control is received by the infrared sensor 24 of the television section 12, the present invention is not limited to such an embodiment. For example, an operational instruction may be received by the DVD section. In that case, the DVD microprocessor is configured to output an operational instruction regarding an operation of the television section 12 to the television section 12, as appropriate.

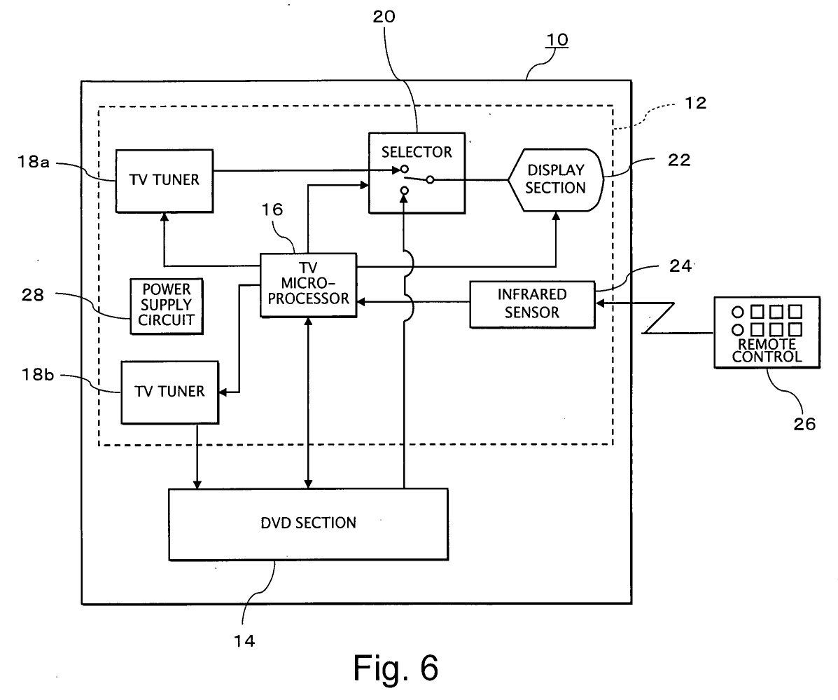

Further, although the present embodiment is configured to include a single television tuner, the present invention is not limited to such an embodiment. For example, a plurality of television tuners 18a and 18b may be employed, as shown in FIG. 6. In the structure shown in FIG. 6, an output from one (18a) of the two television tuners is input to the display section 22 (the selector 20) of the television section 12, and an output from the other television tuner (18b) is input to the DVD section 14. By employing such a structure, even when the television section 12 is being used to view a television broadcast, it is also possible to record a television program being broadcast simultaneously on a channel different from the channel being viewed, that is, “a program in a competing timeslot”. Further, other types of tuners other than a television tuner, such as a BS tuner, a CS tuner, and the like, may also be employed. In that case, it is sufficient to provide a selector between each tuner and the DVD section so that the signal to be output to the DVD section is switched in accordance with the channel to be recorded, as appropriate.

Further, although, in the above-described embodiment, a system capable of recording and playback of data to and from a DVD is used as the optical disk system, the present invention is not limited to such an embodiment. For example, other types of systems for handling other types of optical disks such as HD-DVDs and Blu-ray disks may also be used.

What is claimed is:

1. An optical disk system that records and plays back data to and from an optical disk, wherein the optical disk system is connected to a video display system that displays a video image, the optical disk system comprising:
a communication device that bidirectionally communicates a control signal to and from the video display system;
an input interface that receives input of a video signal from the video display system;
a recording device that records an input video signal onto an optical disk; and
a control device that controls the overall optical disk system, wherein
the control device outputs, through the communication device to the video display system, at least a control signal for instructing switching of a type of video signal that is to be input to the input interface.

2. An optical disk system according to claim 1, wherein the video display system is a television receiver system that includes a tuner for receiving and demodulating a television broadcast, and outputs a television signal received by the tuner to the optical disk system, and wherein
the control device outputs a control signal for instructing switching of a receiving channel of the tuner as the control signal for instructing switching of the type of video signal that is to be input.

3. An optical disk system according to claim 2, wherein the control device further outputs, to the video display system, a control signal for instructing ON/OFF switching of the tuner.

4. An optical disk system according to claim 1, further comprising:
a playback device that plays back data stored on an optical disk; and
an output interface that outputs the played back data to the video display system, wherein
the control device further outputs, to the video display system, a control signal for instructing that a type of signal to be input to a display section of the video display system is switched to the played back signal output from the output interface or other type of video signal.

5. A combination of an optical disk system and a video display system, the combination comprising a television receiver system and an optical disk system connected to the television receiver system, wherein the television receiver system comprises:
a tuner for receiving and demodulating a television broadcast, and for outputting, to the optical disk system, a video signal representing the received television broadcast;
a television side communication device that bidirectionally communicates a control signal to and from the optical disk system; and
a television side control device that controls the overall television receiver system, and controls the television receiver system in accordance with a control signal received from the optical disk system through the television side communication device, and wherein the optical disk system comprises:
a recording device that records a video signal input from the tuner onto an optical disk;
an optical disk side communication device that bidirectionally communicates a control signal to and from the television receiver system; and
an optical disk side control device that controls the overall optical disk system in accordance with a control signal received through the optical disk side communication device, and outputs, to the television receiver system, at least a control signal for instructing switching of a receiving channel of the tuner.
